(19) United States
(12) Patent Application Publication
(10) Pub. No.: US 2007/0254600 A1
(43) Pub. Date: Nov. 1, 2007

(54) PLL CIRCUIT, METHOD FOR PREVENTING INTERFERENCE BETWEEN PLL CIRCUITS, AND OPTICAL DISK APPARATUS COMPRISING THE PLL CIRCUIT

(75) Inventor: Akino ISHII, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION, Kawasaki (JP)

(21) Appl. No.: 11/738,931

(22) Filed: Apr. 23, 2007

(30) Foreign Application Priority Data
Apr. 26, 2006 (JP) 2006-122057

(51) Int. Cl. H04B 1/40; H04B 7/00; H04B 1/06

(52) U.S. Cl. 455/76; 455/260

(57) ABSTRACT

Interference between each other PLL circuits is suppressed. Detector 30 detects whether or not the difference between output signal frequency of PLL circuit 20 having frequency of an input signal swept and a predetermined frequency is not more than first threshold value. Frequency division ratio setting circuit 40 controls to change output signal frequency of a PLL circuit 10 when the difference is not more than the first threshold value. The predetermined frequency is fixed according to output signal frequency of PLL circuit 10. PLL circuit 10 comprises frequency dividers 11, 16, and 17 determining output signal frequency of the PLL circuit 10, and the frequency division ratio of frequency dividers can be changed under control of frequency division ratio setting circuit 40. The frequency division ratio of frequency dividers is determined so that difference between output signal frequency changed by the frequency division ratio setting circuit 40 and original output signal frequency (before change) is not more than a second threshold value.

### FIELD OF THE INVENTION

The present invention relates to a PLL circuit apparatus, a method for preventing interference between PLL circuits, and an optical disk apparatus comprising the PLL circuit, and particularly to a technology that prevents noise interference between PLL circuits when a single apparatus comprises a plurality of PLL (Phase Locked Loop) circuits.

### BACKGROUND OF THE INVENTION

PLL circuits are used for applications such as multiplication, phase locking, and clock extraction. When used for multiplication, PLL circuits are widely used in various electronic equipment in order to generate a high frequency clock signal from a low frequency reference clock signal. Sometimes a clock generating circuit comprising a plurality of PLL circuits is used in these pieces of electronic equipment. For instance, a circuit driving an optical disk comprises a reference PLL circuit that generates a fixed reference clock for a logic circuit and a PLL circuit having a variable frequency range so that the optical disk can be written at a plurality of speeds, multiplied, in a single apparatus. In such a clock generating circuit comprising a plurality of PLL circuits, there is a possibility that a frequency integer times the fixed reference clock output frequency exists within the variable frequency range. When a PLL circuit having a variable output frequency operates with its output frequency being swept and if the output frequency of the PLL circuit is close to a frequency integer times the output frequency of the reference PLL circuit and is within each other's PLL band (PLL loop band), noise interference such as spurious noise between the PLL circuits will cause jitter deterioration.

As a technology intended to prevent such noise interference between PLL circuits, a technology is disclosed in Patent Document 1 in which the influence of the noise interference between PLL circuits is suppressed in a frequency synthesizer circuit having two PLL frequency synthesizer systems by detecting a frequency change of one of the PLL circuits and controlling the charge pump output of the other PLL circuit so that it is constant.

Further, a technology is disclosed in Patent Document 2 that prevents the comparison reference signal components of one PLL system from interfering with another PLL system by maintaining the edge differences between each other of the comparison reference signals equal to or more than a predetermined value in a PLL circuit having a plurality of PLL systems.

[Patent Document 1]

Japanese Patent Kokai Publication No. JP-P2000-68829A

[Patent Document 2]

Japanese Patent Kokai Publication No. JP-A-10-56381

### SUMMARY OF THE DISCLOSURE

The following analyses are given by the present invention. The entire disclosures of the above Patent Documents are incorporated herein by reference thereto.

In Patent Document 1, frequency fluctuations caused by interference are attempted to reduce by stabilizing the charge pump output in the PLL circuit and suppressing the frequency fluctuations of the PLL circuit. However, since noise caused by interference brought about to the voltage-controlled oscillator (VCO) cannot be suppressed, frequency fluctuations caused by the noise component passing through the VCO cannot be reduced. As a result, interference caused by interference between the circuits, such as spurious noise, generates an unnecessary noise component. In other words, the noise caused by the interference is mainly transmitted as power supply noise, and jitter caused by the power supply fluctuations of the VCO is not suppressed even if the influence of power supply fluctuations (noise) is attempted to reduce by stabilizing the charge pump output.

Meanwhile, since the PLL circuit described in Patent Document 2 merely maintains the edge differences between each other of the comparison reference signals equal to or more than a predetermined value, the output signal frequency of each PLL circuit might coincide. Therefore, the interference between the PLL circuits cannot be prevented, and it is difficult to suppress interference such as spurious noise within the PLL band. As the interference such as spurious noise within the PLL band causes jitter to deteriorate as discussed above, mere provision of the edge differences does not help to mitigate the interference such as spurious noise within the PLL band.

It is an object of the present invention to suppress the interference such as spurious noise within the PLL band generated by the output frequency of each PLL circuit.

According to a first aspect of the present invention, a PLL circuit apparatus comprises at least first and second PLL circuits in a single apparatus. The PLL circuit comprises a detector that detects whether or not a difference between an output signal frequency of the second PLL circuit and a predetermined frequency is equal to or less than a first threshold value; and a frequency setting circuit that changes an output signal frequency of the first PLL circuit to an extent where the difference is not more than a second threshold value, which is more than the first threshold value, and is more than the first threshold value when the difference is equal to or less than the first threshold value.

According to a second aspect of the present invention, there is provided a method for preventing interference in a PLL circuit apparatus comprising at least first and second PLL circuits in a single apparatus. The method comprises: detecting whether or not a difference between the output signal frequency of the second PLL circuit and a predetermined frequency is equal to or less than a first threshold value; and changing the output signal frequency of the first PLL circuit to an extent where the difference is not more than a second threshold value, which is more than the first threshold value, and is more than the first threshold value when the difference is equal to or less than the first threshold value.

The predetermined frequency may be a fixed frequency predetermined according to the output signal frequency of the first PLL circuit.

The predetermined frequency may be an integer multiple or an integer fraction of the output signal frequency of the first PLL circuit.

The detector may receive output signals of the first and second PLL circuits, and detect whether or not a difference between an integer multiple or an integer fraction of the output signal frequency of the first PLL circuit and the output signal frequency of the second PLL circuit is equal to or less than the first threshold value.

The first threshold value may be determined from PLL bands of the first and second PLL circuits.

The first PLL circuit may generate a system clock signal used in the single apparatus.

The second threshold value may be within a range in which the frequency of the system clock signal is permitted to vary.

The second PLL circuit may have an output frequency range that includes an integer multiple or an integer fraction of the output signal frequency of the first PLL circuit.

The first PLL circuit may comprise a frequency divider that determines the output signal frequency of the first PLL circuit, and be configured so that a frequency division ratio of the frequency divider can be changed under control of the frequency setting circuit.

The frequency division ratio of the frequency divider may be set so that a difference between the output signal frequency of the first PLL circuit changed under control of the frequency setting circuit and the output signal frequency before the change is more than the first threshold value and is not more than the second threshold value.

The first PLL circuit may comprise: a phase comparator that outputs an output signal according to a phase difference between signals received at two input ends; a voltage-controlled oscillator that oscillates at a frequency corresponding to an amount of a low-frequency component signal in an output signal of the phase comparator, and outputs an output signal; a first frequency divider that divides the frequency of an input reference clock signal and outputs the result to an input end of the phase comparator; a second frequency divider that divides the frequency of the output signal of the voltage-controlled oscillator and outputs the result to the other input end of the phase comparator; and a third frequency divider that divides the frequency of the output signal of the voltage-controlled oscillator and outputs an output signal of the first PLL circuit; and wherein the frequency setting circuit may change the frequency division ratio of at least one of the first, second, and third frequency dividers.

According to a third aspect, there is provided an optical disk apparatus comprising the PLL circuit as mentioned in the first aspect.

In the optical disk, the second PLL circuit may operate in accordance with a write or read frequency of data being recorded to or reproduced from an optical disk.

The meritorious effects of the present invention are summarized as follows.

According to the present invention, in a system constituted by two or more PLL circuit systems in a single apparatus, interference between the PLL circuits with each other can be prevented and interference such as spurious noise in the PLL bands can be suppressed by controlling so that the output frequencies of the PLL circuits do not get close to (or proximity of) an integer multiple of each other.

### BRIEF DESCRIPTIONS OF THE DRAWINGS

FIG. 1 is a block diagram showing the configuration of a PLL circuit relating to a first example of the present invention.

FIGS. 2A and 2B are drawings showing the frequency spectral characteristics of PLL circuits 10 and 20.

FIG. 3 is a drawing showing a method for changing the output frequency of the PLL circuit 10.

FIG. 4 is a flowchart showing the operation of the PLL circuit relating to the first example of the present invention.

FIG. 5 is a block diagram showing the configuration of a PLL circuit relating to a second example of the present invention.

FIG. 6 is a flowchart showing the operation of the PLL circuit relating to the second example of the present invention.

### PREFERRED MODES OF THE INVENTION

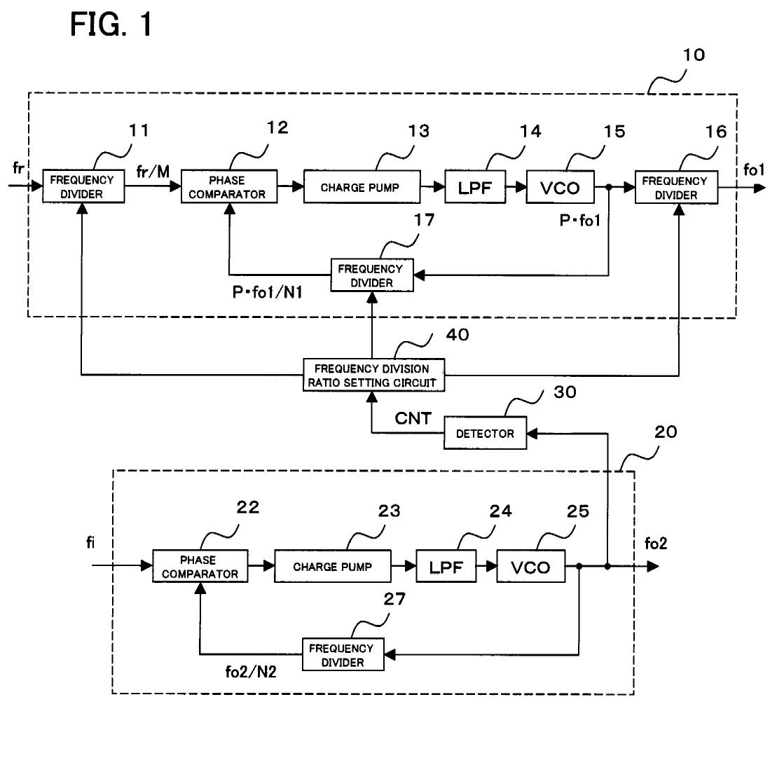

A PLL circuit apparatus relating to an example of the present invention comprises a first PLL circuit (10 in FIG. 1), a second PLL circuit (20 in FIG. 1), a detector (30 in FIG. 1), and a frequency division ratio setting circuit (40 in FIG. 1). The detector (30 in FIG. 1) detects whether or not the difference between the output signal frequency of the second PLL circuit (20 in FIG. 1) and a predetermined frequency is equal to or less than a first threshold value, which indicates these frequencies are close. When this difference is equal to or less than the first threshold value, i.e., when these frequencies are close to each other, the frequency division ratio setting circuit (40 in FIG. 1) controls so that the output signal frequency of the first PLL circuit (10 in FIG. 1) is changed. Here, the predetermined frequency is a fixed frequency predetermined according to the output signal frequency of the first PLL circuit (10 in FIG. 1). Further, the predetermined frequency may be an integer multiple or an integer fraction of the output signal frequency of the first PLL circuit (10 in FIG. 1). Note that the first threshold value is determined from PLL bands of the first and second PLL circuits.

The first PLL circuit (10 in FIG. 1) comprises frequency dividers (11, 16, and 17 in FIG. 1) that determine the output signal frequency (fo1) of the first PLL circuit (10 in FIG. 1), and it is configured so that the frequency division ratio of the frequency dividers can be changed under control of the frequency division ratio setting circuit (40 in FIG. 1). Further, the frequency division ratio of the frequency dividers are set so that the difference between the output signal frequency changed by the frequency division ratio setting circuit (40 in FIG. 1) and the original output signal frequency (before the change) is not more than a second threshold value, i.e., so that the output signal frequency is within a permissible range as a reference clock frequency. Further, the output frequency range of the second PLL circuit (20 in FIG. 1) includes an integer multiple or an integer fraction of the output signal frequency of the first PLL circuit.

The PLL circuit apparatus configured as above includes at least two PLL circuit systems in a single apparatus. When the frequency of the second PLL circuit having at least one variable frequency is changed (for instance when it is in a sweep operation), the frequency of the first PLL circuit generating a fixed reference clock signal is changed within a permissible range as a reference clock signal before the frequency of the second PLL circuit gets close to an integer multiple or an integer fraction of the frequency of the first PLL circuit generating the fixed reference clock signal. By changing the frequency of the reference clock signal, interference such as spurious noise within the PLL band of the PLL circuit can be prevented. Examples will be described in detail with reference to the drawings.

### EXAMPLE 1

FIG. 1 is a block diagram showing the configuration of a PLL circuit relating to a first example of the present invention. In FIG. 1, the PLL circuit comprises a PLL circuit 10 that generates a fixed reference clock, a PLL circuit 20 that outputs an output signal while varying the output signal frequency (for instance sweeping it) within a predetermined frequency range, a detector 30 that detects the output frequency of the PLL circuit 20 and compares it with a predetermined frequency, and a frequency division ratio setting circuit 40 that outputs a signal setting the frequency division ratio to the PLL circuit 10.

The PLL circuit 10 comprises a frequency divider 11 that divides a frequency by M (M is a positive integer), a phase comparator 12, a charge pump 13, a low-pass filter (LPF) 14, a voltage-controlled oscillator (VCO) 15, a frequency divider 16 that divides a frequency by P (P is a positive integer), and a frequency divider 17 that divides a frequency by N1 (N1 is a positive integer). The frequency divider 11 divides a reference oscillation input signal (frequency fr) received by the PLL circuit 10 by M, and outputs the result to an input end of the phase comparator 12. Meanwhile, an oscillation output signal (frequency P·fo1) of the VCO 15 is divided by the frequency divider 17 by N1, and a frequency-divided signal (frequency P·fo1/N1) is supplied to the other input end of the phase comparator 12. The phase comparator 12 compares the phases of the frequency-divided signal of the VCO 15 and the output signal of the frequency divider 11, and drives the charge pump 13 according to the comparison result. An output signal of the charge pump 13 is integrated and converted into a DC voltage by the LPF 14, and outputted to the VCO 15. This DC voltage is a control voltage that controls the oscillation frequency (frequency P·fo1) of the VCO 15. The frequency divider 16 divides the oscillation output signal by P, and outputs an output signal (frequency fo1).

In the PLL circuit 10 configured as described, the frequency fo1 of the output signal of the PLL circuit 10 is locked to a desired frequency f1 by means of a feedback loop of the VCO 15, the frequency divider 17, and the phase comparator 12. In other words, fo1(=f1)=N1·fr/(M·P). Here, the frequency division ratio of the frequency divider 11 (1/M), the frequency division ratio of the frequency divider 16 (1/P), and the frequency division ratio of the frequency divider 17 (1/N1) can be changed by the frequency division ratio setting circuit 40.

Meanwhile, the PLL circuit 20 comprises a phase comparator 22, a charge pump 23, an LPF 24, a VCO 25, and a frequency divider 27 that divides a frequency by N2 (N2 is a positive integer). In the PLL circuit 20, an oscillation output signal (frequency fo2) of the VCO 25 is divided by the frequency divider 27 by N2, and a frequency-divided signal (frequency fo2/N2) is supplied to an input end of the phase comparator 22. The phase comparator 22 compares the phases of the frequency-divided signal of the VCO 25 and an input comparison signal of the PLL circuit 20 (frequency fi) and drives the charge pump 23 according to the comparison result. An output signal of the charge pump 23 is integrated and converted into a DC voltage by the LPF 24, and outputted to the VCO 25. This DC voltage is a control voltage that controls the oscillation frequency fo2 of the VCO 25. An output signal of the VCO becomes an output signal of the PLL circuit 20.

In the PLL circuit 20 configured as described, the frequency fo2 of the output signal of the PLL circuit 20 is locked to the frequency fi by means of a feedback loop of the VCO 25, the frequency divider 27, and the phase comparator 22. In other words, fo2=N2*fi. Further, the frequency fi of the input comparison signal is varied within a range where the frequency fo2 of the output signal of the VCO 25 includes an integer multiple or an integer fraction of the frequency fo1 of the output signal of the PLL circuit 10.

The detector 30 compares the output frequency fo2 of the output signal of the PLL circuit 20 with the desired output frequency f1 of the output signal of the PLL circuit 10, and outputs a frequency division ratio control signal CNT to the frequency division ratio setting circuit 40 according to the comparison result. The frequency division ratio setting circuit 40 sets the frequency division ratio in the PLL circuit 10 according to the frequency division ratio control signal CNT. More concretely, the frequency division ratio of at least one of the frequency dividers 11, 16, and 17 is changed so that the output frequency fo2 of the PLL circuit 20 does not get close to an integer multiple or an integer fraction of the output frequency fo1 of the PLL circuit 10, i.e., so that they do not have a relationship of fundamental and harmonic frequencies. In other words, at least one of the integers N1, M and P is changed.

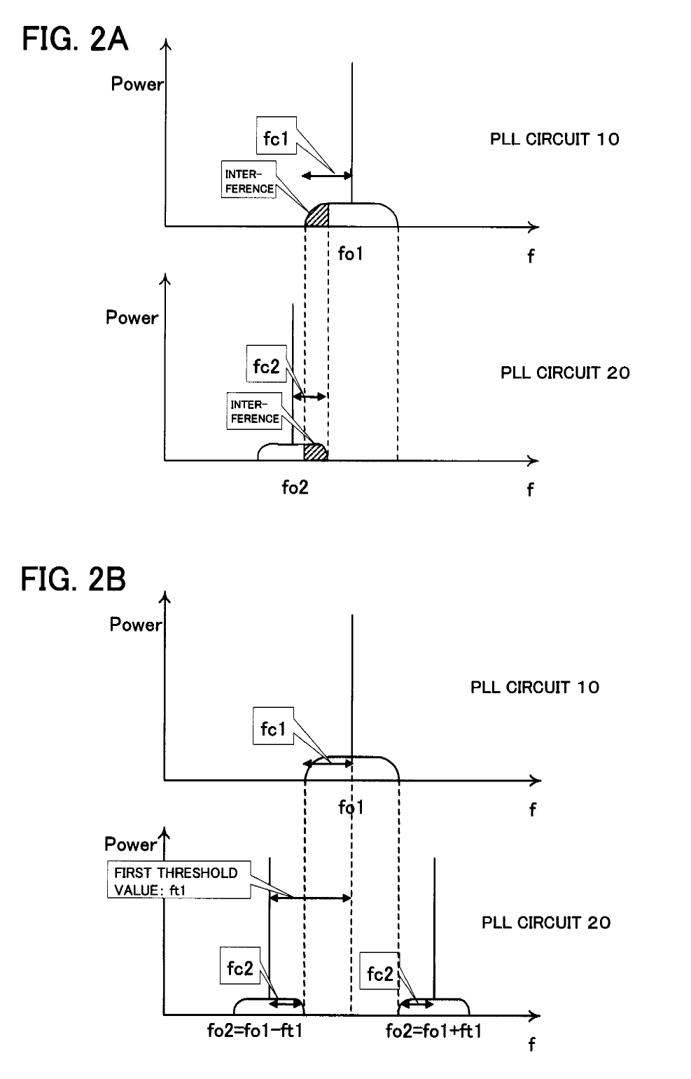

A method for changing the output frequency fo1 of the PLL circuit 10 will be described. FIGS. 2A and 2B are drawings showing the frequency spectral characteristics of the PLL circuits 10 and 20. In FIGS. 2A and 2B, the PLL bandwidth of the PLL circuit 10 is fc1, the PLL bandwidth of the PLL circuit 20 is fc2, and the aforementioned first threshold value is ft1. As shown in FIG. 2A, when |fo1−fo2|≦ft1=fc1+fc2, the PLL bands of the PLL circuits 10 and 20 overlap and interference occurs between the PLL circuits. In this case, the output frequency fo1 of the PLL circuit 10 is changed so that |fo1−fo2|>ft1=fc1+fc2, as shown in FIG. 2B. By changing the frequency, the PLL bands do not overlap with each other anymore, and the interference between the PLL circuits can be suppressed.

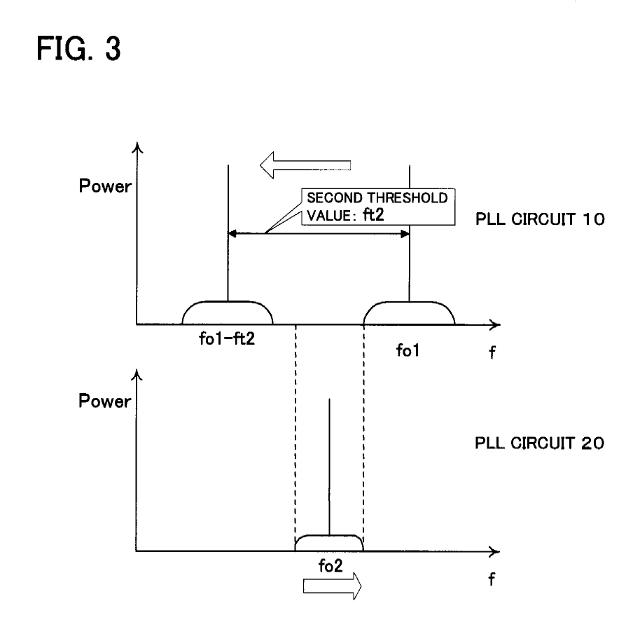

Further, the output frequency of the PLL circuit 10 is varied within a permissible range as a reference clock, i.e., the range in which the frequency of the clock signal is permitted to vary. FIG. 3 is a drawing showing the method for changing the output frequency of the PLL circuit 10. In FIG. 3, ft2 is the aforementioned second threshold value. For instance, let's assume that the output frequency fo2 of the PLL circuit 20 has increased and has gotten close to the output frequency fo1 of the PLL circuit 10, and as a result, a state of |fo1−fo2|=ft1 results. In this case, the output frequency fo1 of the PLL circuit 10 is changed (i.e., decreased) so that it is within the frequency variation permissible range, for instance to fo1−ft2, as is illustrated by arrows in FIG. 3.

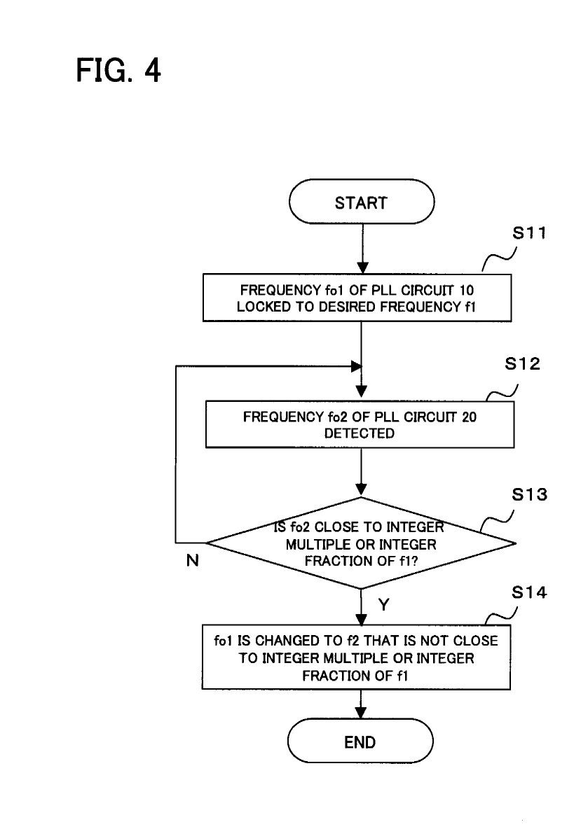

FIG. 4 is a flowchart showing the operation of the PLL circuit relating to the first example of the present invention. First, let's assume that the output frequency fo1 of the PLL circuit 10 is locked to the frequency f1, a desired reference clock frequency (step S11). The detector 30 monitors the output frequency fo2, which is a variable frequency, of the PLL circuit 20 (step S12), and determines whether or not the output frequency fo2 of the PLL circuit 20 is close to an integer multiple or an integer fraction of the desired frequency f1 of the PLL circuit 10 (step S13). When it is determined that it is not close in the step S13, the steps S12 and S13 are repeated. When it is determined that the output frequency fo2 of the PLL circuit 20 is close to an integer multiple or an integer fraction of the frequency f1 of the PLL circuit 10 in the step S13, the detector 30 outputs the frequency division ratio control signal CNT that controls the frequency division ratio setting circuit 40 to the frequency division ratio setting circuit 40. The frequency division ratio setting circuit 40 changes the frequency division ratio or ratios in the PLL circuit 10. By changing the frequency division ratio(s), the output frequency fo1 of the PLL circuit 10 is changed to a frequency f2 that is within the permissible range as a reference clock and is not close to an integer multiple or an integer fraction of f1 (step S14). The term “close” used herein denotes that the frequency of the first and second PLL circuits are close to each other such that interference occurs between them.

The PLL circuit of the present example operates as described above, and it is controlled so that the frequency of the PLL circuit 10 is within the permissible range as a reference clock, and is also within a range where the desired frequency f1 of the PLL circuit 10 and the output frequency fo2 of the PLL circuit 20 are not close to an integer multiple of each other (a relationship of fundamental and harmonic frequencies). Since the output frequencies of the PLL circuits do not get close to an integer multiple of each other, interference such as spurious noise between the PLL circuits can be prevented, and the deterioration of PLL jitter caused by interference such as spurious noise can be prevented as well.

For instance, the PLL circuit described above is applied to an optical disk apparatus. In an optical disk apparatus, the output signal of the PLL circuit 10 is used as a system clock signal of the apparatus, such as the clock signal for DRAM. Further, the PLL circuit 20 operates in accordance with the write or read frequency of data being recorded to or reproduced from the optical disk, and the output signal of the PLL circuit 20, in which the frequency of the output signal fluctuates, is used as a clock signal necessary for access to the optical disk. In such an optical disk apparatus, an integer multiple of the frequency of the system clock signal may exist within a variable range of the frequency of signals generated during recording or reproducing of the optical disk. By applying the PLL circuit of the present example, interference such as spurious noise within the PLL bands can be suppressed, and a highly reliable optical disk apparatus can be provided.

### EXAMPLE 2

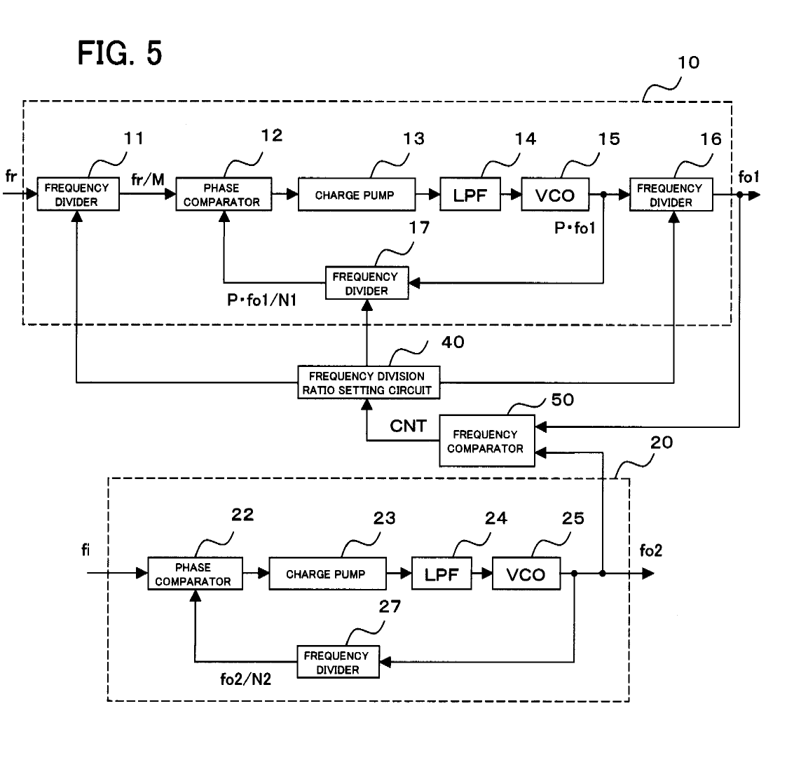

FIG. 5 is a block diagram showing the configuration of a PLL circuit relating to a second example of the present invention. In FIG. 5, the symbols same as the ones in FIG. 1 indicate the same things, thus the explanations of them will be omitted. The PLL circuit shown in FIG. 5 comprises a frequency comparator 50 that receives the output signals of the PLL circuits 10 and 20 instead of the detector 30 in FIG. 1. The frequency comparator 50 compares the output frequency fo1 of the PLL circuit 10 and the output frequency fo2 of the PLL circuit 20, and outputs a frequency division ratio control signal CNT to the frequency division ratio setting circuit 40 according to the comparison result. The frequency division ratio setting circuit 40 sets the frequency division ratio or ratios of the PLL circuit 10 according to the frequency division ratio control signal CNT.

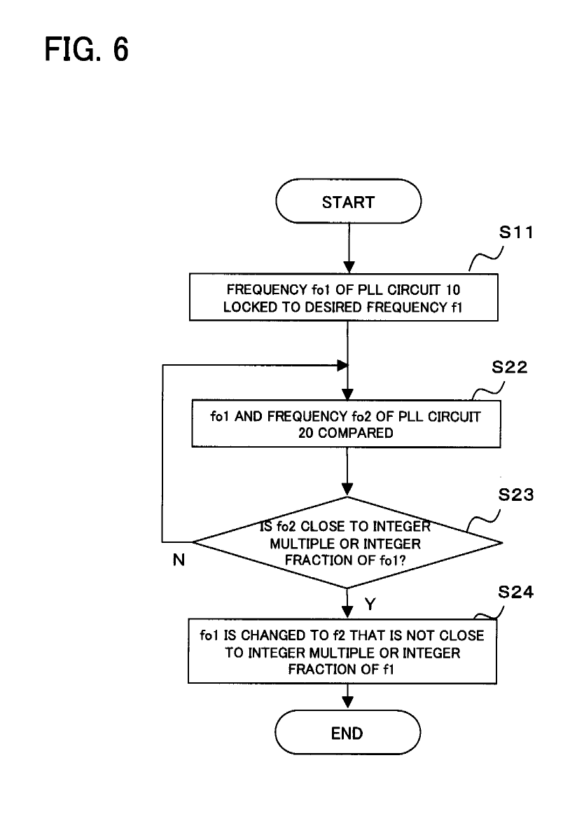

FIG. 6 is a flowchart showing the operation of the PLL circuit relating to the second example of the present invention. In FIG. 6, steps represented by the same symbols as the ones in FIG. 4 indicate the same processings, thus the explanation of them will be omitted. The frequency comparator 50 monitors the output frequency fo1 of the PLL circuit 10 and the output frequency fo2, which is a variable frequency, of the PLL circuit 20 (step S22). Then it determines whether or not the output frequency fo2 of the PLL circuit 20 is close to an integer multiple or an integer fraction of the output frequency fo1 of the PLL circuit 10 (step S23). When it is determined that it is not close in the step S23, the steps S22 and S23 are repeated. When it is determined that the output frequency fo2 of the PLL circuit 20 is close to an integer multiple or an integer fraction of the output frequency fo1 of the PLL circuit 10, the frequency comparator 50 outputs the frequency division ratio control signal CNT that controls the frequency division ratio setting circuit 40 to the frequency division ratio setting circuit 40, and the frequency division ratio setting circuit 40 changes the frequency division ratio or ratios in the PLL circuit 10. By changing the frequency division ratio, the output frequency fo1 of the PLL circuit 10 is changed to the frequency f2 that is within the permissible range as a reference clock and is not close to an integer multiple or an integer fraction of f1 (step S24).

As described, the PLL circuit relating to the second example is controlled so that the output frequency fo1 of the PLL circuit 10 and the output frequency fo2 of the PLL circuit 20 are not close to an integer multiple of each other, as in the first example. Therefore, interference such as spurious noise between the PLL circuits can be prevented, and the deterioration of PLL jitter caused by interference such as spurious noise can be prevented as well.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A Phase Locked Loop, referred to as “PLL” herein after, circuit, comprising:
at least first and second PLL circuits in a single apparatus;
a detector that detects whether or not a difference between an output signal frequency of said second PLL circuit and a predetermined frequency is equal to or less than a first threshold value; and
a frequency setting circuit that changes an output signal frequency of said first PLL circuit to an extent where said difference is not more than a second threshold value, which is more than said first threshold value, and is more than said first threshold value when said difference is equal to or less than said first threshold value.

2. The PLL circuit as defined in claim 1 wherein said predetermined frequency is a fixed frequency predetermined according to the output signal frequency of said first PLL circuit.

3. The PLL circuit as defined in claim 2 wherein said predetermined frequency is an integer multiple or an integer fraction of the output signal frequency of said first PLL circuit.

4. The PLL circuit as defined in claim 1 wherein said detector receives output signals of said first and second PLL circuits, and detects whether or not a difference between an integer multiple or an integer fraction of the output signal frequency of said first PLL circuit and the output signal frequency of said second PLL circuit is equal to or less than said first threshold value.

5. The PLL circuit as defined in claim 1 wherein said first threshold value is determined from PLL bands of said first and second PLL circuits.

6. The PLL circuit as defined in claim 1 wherein said first PLL circuit generates a system clock signal used in said single apparatus.

7. The PLL circuit as defined in claim 1 wherein said second threshold value is within a range in which the frequency of said system clock signal is permitted to vary.

8. The PLL circuit as defined in claim 1 wherein said second PLL circuit has an output frequency range that includes an integer multiple or an integer fraction of the output signal frequency of said first PLL circuit.

9. The PLL circuit as defined in claim 1 wherein said first PLL circuit comprises a frequency divider that determines the output signal frequency of said first PLL circuit, and is configured so that a frequency division ratio of said frequency divider can be changed under control of said frequency setting circuit.

10. The PLL circuit as defined in claim 9 wherein the frequency division ratio of said frequency divider is set so that a difference between the output signal frequency of said first PLL circuit changed under control of said frequency setting circuit and the output signal frequency before the change is more than said first threshold value and is not more than said second threshold value.

11. The PLL circuit as defined in claim 9 wherein said first PLL circuit comprises:
a phase comparator that outputs an output signal according to a phase difference between signals received at two input ends;
a voltage-controlled oscillator that oscillates at a frequency corresponding to an amount of a low-frequency component signal in an output signal of said phase comparator, and outputs an output signal;
a first frequency divider that divides the frequency of an input reference clock signal and outputs the result to an input end of said phase comparator;
a second frequency divider that divides the frequency of the output signal of said voltage-controlled oscillator and outputs the result to the other input end of said phase comparator; and
a third frequency divider that divides the frequency of the output signal of said voltage-controlled oscillator and outputs an output signal of said first PLL circuit; and
wherein said frequency setting circuit changes the frequency division ratio of at least one of said first, second, and third frequency dividers.

12. An optical disk apparatus comprising the PLL circuit as defined in claim 1.

13. The optical disk apparatus as defined in claim 12 wherein said second PLL circuit operates in accordance with a write or read frequency of data being recorded to or reproduced from an optical disk.

14. A method for preventing interference in a Phase Locked Loop, referred to as “PLL” hereinafter, circuit comprising:
providing a circuit comprising at least first and second PLL circuits in a single apparatus;
detecting whether or not a difference between an output signal frequency of said second PLL circuit and a predetermined frequency is equal to or less than a first threshold value; and
changing the output signal frequency of said first PLL circuit to an extent where said difference is not more than a second threshold value, which is more than said first threshold value, and is more than said first threshold value when said difference is equal to or less than said first threshold value.

15. The method for preventing interference in a PLL circuit as defined in claim 14 wherein said predetermined frequency is a fixed frequency predetermined according to the output signal frequency of said first PLL circuit.

16. The method for preventing interference in a PLL circuit as defined in claim 15 wherein said predetermined frequency is an integer multiple or an integer fraction of the output signal frequency of said first PLL circuit.

17. The method for preventing interference in a PLL circuit as defined in claim 14 wherein said first threshold value is determined from PLL bands of said first and second PLL circuits.

18. The method for preventing interference in a PLL circuit as defined in claim 14 wherein said second threshold value is within a range in which the frequency of a system clock signal used in said single apparatus is permitted to vary.

19. The method for preventing interference in a PLL circuit as defined in claim 14 wherein the output frequency range of said second PLL circuit includes an integer multiple or an integer fraction of the output signal frequency of said first PLL circuit.

20. The method for preventing interference in a PLL circuit as defined in claim 14 wherein a frequency division ratio of a frequency divider that determines the output signal frequency of said first PLL circuit is changed when the output signal frequency of said first PLL circuit is changed.

21. The method for preventing interference in a PLL circuit as defined in claim 20 wherein said frequency division ratio is set so that a difference between the output signal frequency of said first PLL circuit changed and the output signal frequency before the change is more than said first threshold value and is not more than said second threshold value.
